(19) United States
(12) Patent Application Publication
(10) Pub. No.: US 2026/0191379 A1
(43) Pub. Date: Jul. 9, 2026

(54) SURFACE CLEANER

(71) Applicant: SHARKNINJA OPERATING LLC, Needham, MA (US)

(72) Inventors: Ryan COPELAND, Watertown, MA (US); Austin WAID-JONES, Danvers, MA (US); Xavier CULLERE, Newton, MA (US); Zach SHONFELD, Cambridge, MA (US); Alexander CALVINO, Cranston, RI (US); Daniel R. DER MARDEROSIAN, Westwood, MA (US); Scott MCDONALD, Needham, MA (US); Steven GACIN, Pawtucket, RI (US); Peng Fei LIU, Shenzhen (CN); Baodong LU, Suzhou (CN); Leo YAMAZAKI, Brighton, MA (US); Yang ZHAO, Shenzhen (CN); Jikang LU, Suzhou (CN); Kai XU, Suzhou (CN); Yuan XIE, Suzhou (CN)

(21) Appl. No.: 19/551,217

(22) Filed: Feb. 26, 2026

Related U.S. Application Data
(63) Continuation of application No. PCT/US2024/044420, filed on Aug. 29, 2024.
(60) Provisional application No. 63/535,257, filed on Aug. 29, 2023.

(51) Int. Cl. A47L 9/04; A47L 9/00; F16H 37/02

(52) U.S. Cl. CPC A47L 9/0444; A47L 9/009; A47L 9/0488; F16H 37/02

(57) ABSTRACT

A surface cleaner may include an upright section, a cleaning head having a suction inlet and an agitator, the upright section pivotally coupled to the cleaning head, a plurality of wheels coupled to opposing sides of the cleaning head, a suction motor fluidly coupled to the suction inlet, and a reverse cleaning assembly coupled to the cleaning head and extending between the agitator and the plurality of wheels, wherein rotational movement of at least one of the plurality of wheels is transferred to the reverse cleaning assembly.

### CROSS-REFERENCE TO RELATED APPLICATIONS

The present application is a continuation of PCT Patent Application No. PCT/US 2024/044420 filed Aug. 29, 2024, which claims the benefit of U.S. Provisional Application Ser. No. 63/535,257 filed on Aug. 29, 2023, entitled Surface Cleaner, both of which are fully incorporated herein by reference.

### TECHNICAL FIELD

The present disclosure generally relates to surface cleaners and, more particularly, to a cleaning head for a surface cleaner.

### BACKGROUND

A surface cleaning apparatus may be used to clean a variety of surfaces. Some surface cleaning apparatuses include a rotating agitator or a pad for cleaning. One non-limiting example of a surface cleaning apparatus may include an upright vacuum, which may include a cleaning head. The cleaning head may include an agitator, a plurality of wheels, and a squeegee disposed between the agitator and the plurality of wheels. When the cleaning head moves along a surface to be cleaned (e.g., a floor) according to a forward direction of movement, the squeegee may collect debris from the surface to be cleaned at a location between the squeegee and the agitator (e.g., collect debris forward of the squeegee). When the cleaning head moves along the surface to be cleaned according to a rearward direction of movement, the squeegee may collect debris from the surface to be cleaned at a location between the squeegee and the wheels (e.g., collect debris behind the squeegee). Collection of debris behind the squeegee may result in debris piles collecting on the surface to be cleaned when the cleaning head transitions from the rearward direction of movement to the forward direction of movement. As a result, a user may be required to maneuver the cleaning head such that the cleaning head passes over the debris pile according to the forward direction of movement, which may be inconvenient to the user.

### BRIEF DESCRIPTION OF THE DRAWINGS

Reference should be made to the following detailed description which should be read in conjunction with the following figures, wherein like numerals represent like parts.

FIG. 1 is an example schematic view of a surface cleaner consistent with embodiments of the present disclosure.

FIG. 2A is a side view of the interior of the example surface cleaner of FIG. 1, consistent with the present disclosure.

FIG. 2B is bottom view of the interior of the example surface cleaner of FIG. 2A, consistent with the present disclosure.

FIG. 2C is a perspective view of a drive mechanism for a passive roller of the example surface cleaner 100 of FIG. 2A, consistent with the present disclosure.

FIG. 2D is a top perspective view of a nozzle assembly for the example surface cleaner 100 of FIG. 2A, consistent with the present disclosure.

FIG. 2E is a bottom perspective view of a nozzle assembly for the example surface cleaner 100 of FIG. 2A, consistent with the present disclosure.

FIG. 3A is a side view of one example of a passive roller for the surface cleaner 100 of FIG. 1, consistent with the present disclosure.

FIG. 3B is a front view of the example passive roller of FIG. 3A, consistent with the present disclosure.

FIG. 3C is a back view of one example of a covering strip for the passive roller of FIG. 3A, consistent with the present disclosure.

FIG. 3D is a top view of one example of a covering strip for the passive roller of FIG. 3A, consistent with the present disclosure.

FIG. 3E is a front view of one example of a covering strip for the passive roller of FIG. 3A, consistent with the present disclosure.

FIG. 3F is a front view of another example of a passive roller for the surface cleaner 100 of FIG. 1, consistent with the present disclosure.

FIG. 4A is a schematic view of an illustrative embodiment of an articulating squeegee for the example surface cleaner of FIG. 1, consistent with the present disclosure.

FIG. 4B is a schematic view of an illustrative embodiment of an articulating squeegee for the example surface cleaner of FIG. 1, consistent with the present disclosure.

FIG. 4C is a schematic view of another illustrative embodiment of an articulating squeegee for the example surface cleaner of FIG. 1, consistent with the present disclosure.

FIG. 4D is schematic view of another illustrative embodiment of an articulating squeegee for the example surface cleaner of FIG. 1, consistent with the present disclosure.

FIG. 4E is another schematic view the articulating squeegee of FIG. 4D, consistent with the present disclosure.

FIG. 4F is another schematic view the articulating squeegee of FIG. 4D, consistent with the present disclosure.

FIG. 4G is a schematic view of yet another illustrative embodiment of an articulating squeegee for the example surface cleaner of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The present disclosure is generally directed to a surface cleaner. The surface cleaner may include a upright section, a cleaning head pivotally coupled to the upright section, at least one wheel rotatably coupled to the cleaning head, at least one agitator (e.g., a brush roll) rotatably coupled to the cleaning head for agitating a surface to be cleaned, and a rear cleaning assembly disposed between the at least one wheel and the at least one agitator. The upright section includes a handle such that a user can exert a force (e.g., via a pull stroke or a push stroke) on the upright section that causes the cleaning head to move along the surface to be cleaned. For example, the user exerted force may cause the cleaning head to move in a forward direction (e.g., caused by push stroke) or a rearward direction (e.g., caused a pull stroke). The forward direction may generally be described as a direction extending from the wheel towards the agitator and the rearward direction may generally be described as a direction extending from the agitator towards the wheel.

When the cleaning head moves in the forward and rearward direction, the agitator and the rear cleaning assembly may be configured to cooperate to encourage debris to enter a debris inlet (e.g., a suction inlet) within the cleaning head. For example, the cleaning head may be configured to selectively operate in a reverse cleaning mode, whereby the rear cleaning assembly is configured to urge debris towards the suction inlet on a push stroke, but also to either allow debris to pass through to the suction inlet, or to urge the debris toward the suction inlet, on a pull stroke. Such a configuration may mitigate (e.g., prevent) a formation of debris piles rearward of the rear cleaning assembly.

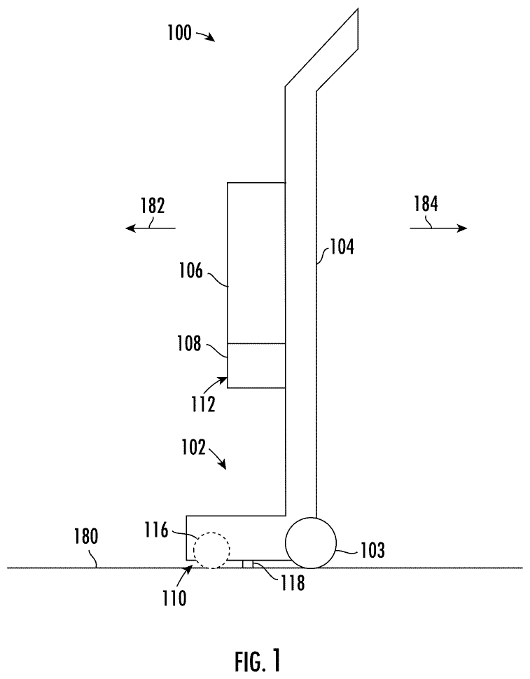

FIG. 1 is an example schematic view of a surface cleaner 100 consistent with embodiments of the present disclosure. The surface cleaner 100 includes a cleaning head 102 having one or more nozzle wheels 103 rotatably coupled thereto, an upright section 104, a dust cup 106, a suction motor 108, and an agitator 116 (e.g., a brush roll). The suction motor 108 is fluidly coupled to a suction inlet 110 of the cleaning head 102. The suction motor 108 is configured to generate an airflow into the suction inlet 110 of the cleaning head 102 such that debris can be suctioned from a surface to be cleaned 180 (e.g., a floor). At least a portion of debris that is entrained within the airflow is deposited in the dust cup 106 for later disposal (e.g., by a user of the surface cleaner 100). After passing through the dust cup 106, the airflow is exhausted from the suction motor 108 at an exhaust outlet 112.

The surface cleaner 100 is configured to be moved relative to the surface to be cleaned 180 according at least to direction-1 182 and direction-2 184. As used herein, movement of the surface cleaner 100 by a user in the direction indicated by direction-1 182 is considered a forward direction, i.e., the user is pushing the surface cleaner 100 away from the user, while movement of the surface cleaner 100 by a user in the direction indicated by direction-2 184 is considered a reverse direction, i.e., the user is pulling the surface cleaner 100 back towards the user. In other words the direction-1 182 extends from the one or more nozzle wheels 103 towards the agitator 116 and the direction-2 184 extends from the agitator 116 towards the one or more nozzle wheels 103.

As shown, the cleaning head 102 includes a rear cleaning assembly 118. The rear cleaning assembly 118 is disposed between the one or more nozzle wheels 103 and the agitator 116. For example, the rear cleaning assembly 118 may extend along an axis that is substantially parallel to a rotation axis of the one or more nozzle wheels 103 and/or the agitator 116. The rear cleaning assembly 118 is configured to cooperate with the agitator 116 to encourage the passage of debris into the suction inlet 110 when the surface cleaner 100 is moved according to direction-1 182 and direction-2 184. In some instances, at least one of the one or more nozzle wheels 103 may be configured such that rotational movement of the at least one nozzle wheel 103 is transferred to the rear cleaning assembly 118 such that a corresponding movement is caused in the rear cleaning assembly 118.

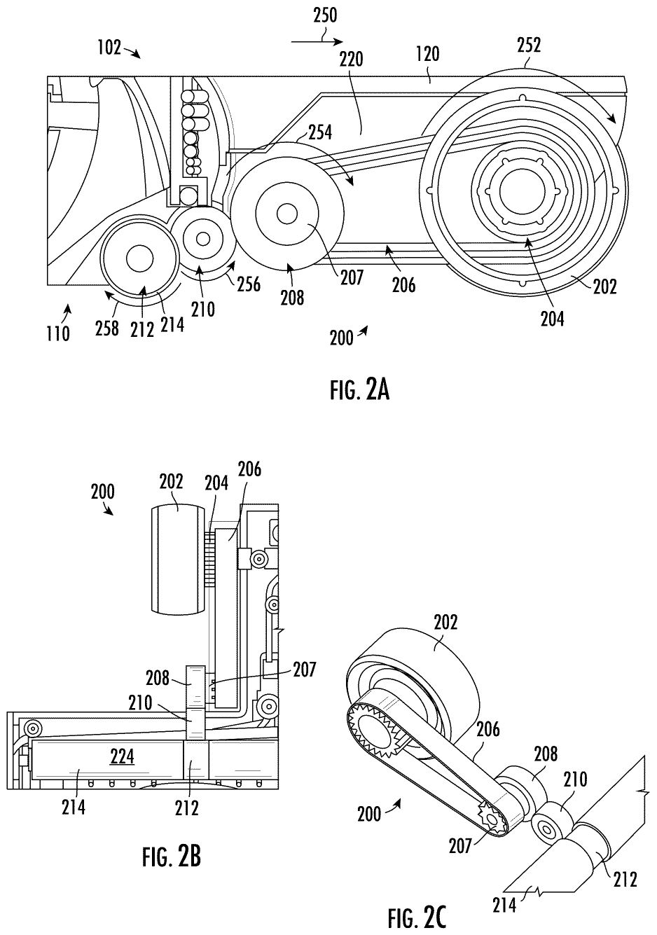

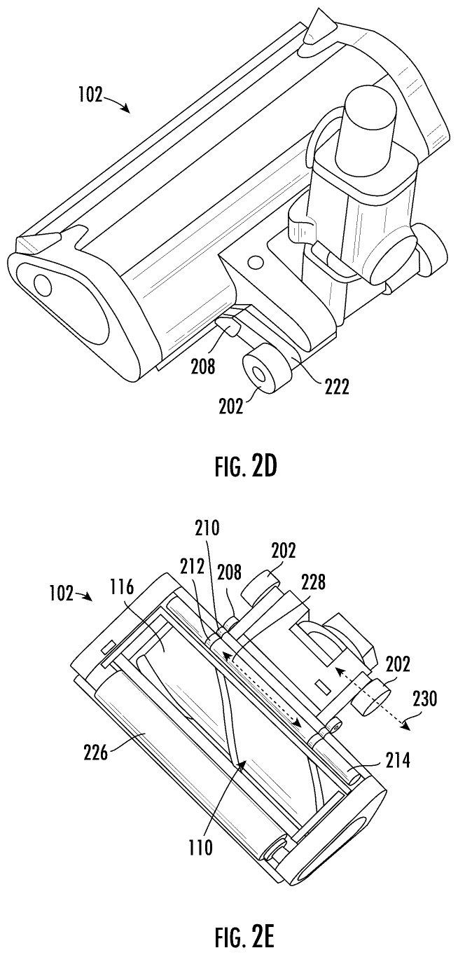

FIG. 2A is a side view of the interior of the example surface cleaner 100 of FIG. 1, consistent with the present disclosure. The example of FIG. 2A illustrates one illustrative embodiment of a reverse cleaning assembly 200 incorporated into the cleaning head 102. The reverse cleaning assembly 200 is an example of the rear cleaning assembly 118.

The reverse cleaning assembly 200 includes a plurality of nozzle wheels 202 (which are examples of the nozzle wheel 103 of FIG. 1) rotatably coupled to opposing sides of the cleaning head 102. As shown, the plurality of nozzle wheels 202 may be positioned rearward of a passive roller 214 such that the passive roller 214 is disposed between the agitator 116 and the nozzle wheels 202. At least one of the plurality of nozzle wheels 202 are connected to the passive roller 214 via a transmission system that is configured to transfer rotational movement of at least one of the plurality of nozzle wheels 202 to the passive roller 214.

For example, the transmission system may include the nozzle wheel 202, a first gear 204 disposed coaxially on the nozzle wheel 202, a drive belt 206, a first transmission wheel 208, a second gear 207 disposed coaxially on the first transmission wheel 208, a second transmission wheel 210, and a passive roller 214 that includes a driven region 212 (e.g., a portion of a core of the passive roller 214) configured to engage the second transmission wheel 210. At least a portion of the nozzle wheel 202, the drive belt 206, the first transmission wheel 208, the second transmission wheel 210, and/or the driven region 212 may be constructed of rubber or some other elastomeric material. The nozzle wheel 202, the first gear 204, and the second gear 207 may include, for example, Acrylonitrile Butadiene Styrene (ABS), but may be constructed of other appropriate materials as would be known to a person of skill in the art. In some instances, the first transmission wheel 208, the second transmission wheel 210, and/or the driven region 212 may be in the form of gears.

The nozzle wheel 202, the first gear 204, the drive belt 206, the first transmission wheel 208, the second transmission wheel 210, and the driven region 212 of the passive roller 214 can be disposed at (e.g., rotatably coupled to) a first side 220 of the cleaning head 102 (e.g., coupled to a base 120 of the cleaning head 102). The nozzle wheel 202 is a large (e.g., having a diameter greater than that of the passive roller 214) wheel configured to contact the surface to be cleaned 180. The nozzle wheel 202 is urged to rotate when the surface cleaner 100 is moved in either a forward direction or a reverse direction. In some embodiments, the nozzle wheel 202 may have a friction increasing material, such as rubber or other elastomeric material, coupled to an outer perimeter of the nozzle wheel 202. The friction increasing material is configured to increase the friction between the nozzle wheel 202 and the surface to be cleaned 180, which may increase the rotational force when the surface cleaner 100 is moved by the user.

The first gear 204 is coupled to the nozzle wheel 202 such that the first gear 204 rotates with the nozzle wheel 202. The first gear 204 is configured to cooperate with the drive belt 206 such that rotation of the first gear 204 causes a corresponding movement of the drive belt 206. The drive belt 206 is configured to cooperate with the second gear 207 such that the second gear 207 rotates in response to movement of the drive belt 206. The second gear 207 is coupled to the first transmission wheel 208 such that the first transmission wheel 208 rotates with the second gear 207. The first transmission wheel 208 is configured to engage the second transmission wheel 210 such that rotational movement of the first transmission wheel 208 is transferred to the second transmission wheel 210. The second transmission wheel 210 is configured to engage the passive roller 214 such that rotation of the second transmission wheel 210 is transferred to the passive roller 214. The inclusion of the second transmission wheel 210 allows the passive roller 214 and the nozzle wheel 202 to rotate according to a common rotation direction.

For example, when the surface cleaner 100 is moved in the reverse direction 250, the nozzle wheel 202 rotates in a clockwise direction, as denoted by rotation-1 252. Rotation of the nozzle wheel 202 causes the first gear 204 to rotate. Rotation of the nozzle wheel 202 and first gear 204 urges the drive belt 206 to cause a rotation in the second gear 207 and the first transmission wheel 208 in the same direction as the rotation of nozzle wheel 202, as denoted by direction-2 254. The second transmission wheel 210 is rotatably coupled with the first transmission wheel 208 and configured to rotate in the opposite direction of the first transmission wheel 208, as shown by direction-3 256, when urged by the rotation of the first transmission wheel 208. The driven region 212 of the passive roller 214 is rotatably coupled with the second transmission wheel 210 and configured to rotate in the opposite direction of the second transmission wheel 210, as shown by direction-4 258, when urged by the rotation of the second transmission wheel 210. The driven region 212 is coaxially coupled with (or formed from) the passive roller 214 (see, for example, FIG. 2B), such that the rotation of the driven region 212, when urged to rotate by the rotation of the second transmission wheel 210, will cause the passive roller 214 to rotate in the same direction, i.e., direction-4 258, as the driven region 212. When the user moves the surface cleaner 100 in the reverse direction, i.e., pulling the surface cleaner 100 towards the user, the rotation of the passive roller 214 in the direction-4 258 may be configured to urge debris on the surface to be cleaned 180 towards the suction inlet 110 to aid in the collection of the debris by the surface cleaner 100.

FIG. 2B is a bottom view of the interior of the example surface cleaner 100 of FIG. 2A, consistent with the present disclosure. The bottom view of FIG. 2B illustrates the mounting of the reverse cleaning assembly 200, including the nozzle wheel 202, the first gear 204, the drive belt 206, the second gear 207, the first transmission wheel 208, the second transmission wheel 210, the driven region 212, and the passive roller 214 into the base 120 of the cleaning head 102. As shown, the driven region 212 of the passive roller 214 may be disposed between sections of an agitation material 224 (e.g., a micro-fiber, bristles, and/or any other agitation material). In some instances, the driven region 212 may be formed from a core of the passive roller 214. In other instances, the driven region 212 may be a separate element that couples to the passive roller 214. For example, the passive roller 214 may include two agitation bodies coupled together via the driven region 212.

FIG. 2C is a perspective view of the reverse cleaning assembly 200 of the example surface cleaner 100 of FIG. 2A, consistent with the present disclosure. The perspective view of FIG. 2C illustrates the coupling and operation of the nozzle wheel 202, the first gear 204, the drive belt 206, the second gear 207, the first transmission wheel 208, the second transmission wheel 210, the driven region 212, and the passive roller 214. As shown, the transmission wheels 208 and 210 and the driven region 212 are non-geared. Such a configuration may allow for slip between one or more of the transmission wheels 208 and/or 210 and/or the driven region 212 (e.g., in the event of stuck condition of the passive roller 214). However, in other instances, one or more of the transmission wheels 208 and/or 210 and/or the driven region 212 may include a geared surface.

FIG. 2D is a top perspective view of an example of the cleaning head 102 having the reverse cleaning assembly 200 included therewith, consistent with the present disclosure. As shown, a reverse cleaning assembly cover 222 covers at least a portion of the reverse cleaning assembly 200. For example, the nozzle wheel 202 may be disposed external to the reverse cleaning assembly cover 222. In this example, one or more of the transmission wheels 208 and/or 210 may be external to the reverse cleaning assembly cover 222. Such a configuration may encourage easier maintenance of the reverse cleaning assembly 200.

FIG. 2E is a bottom perspective view of an example of the cleaning head 102 having the reverse cleaning assembly 200 included therewith, consistent with the present disclosure. FIG. 2E illustrates the mounting of the reverse cleaning assembly 200, including the nozzle wheel 202, the first gear 204, the drive belt 206, the second gear 207, the first transmission wheel 208, the second transmission wheel 210, the driven region 212, and the passive roller 214 into the base 120 of the cleaning head 102. As also shown, the cleaning head 102 includes the agitator 116 disposed between a forward roller 226 and the nozzle wheels 202. The passive roller 214 is disposed between the agitator 116 and the nozzle wheels 202. A passive roller rotation axis 228 extends substantially parallel to a nozzle wheel rotation axis 230, wherein the passive roller rotation axis 228 is spaced apart from the nozzle wheel rotation axis 230 (e.g., spaced apart by a distance that is equal to or greater than a maximum diameter of the passive roller 214). As also shown, each of the nozzle wheels 202 may cooperate to drive the passive roller 214 (e.g., via independent transmission systems).

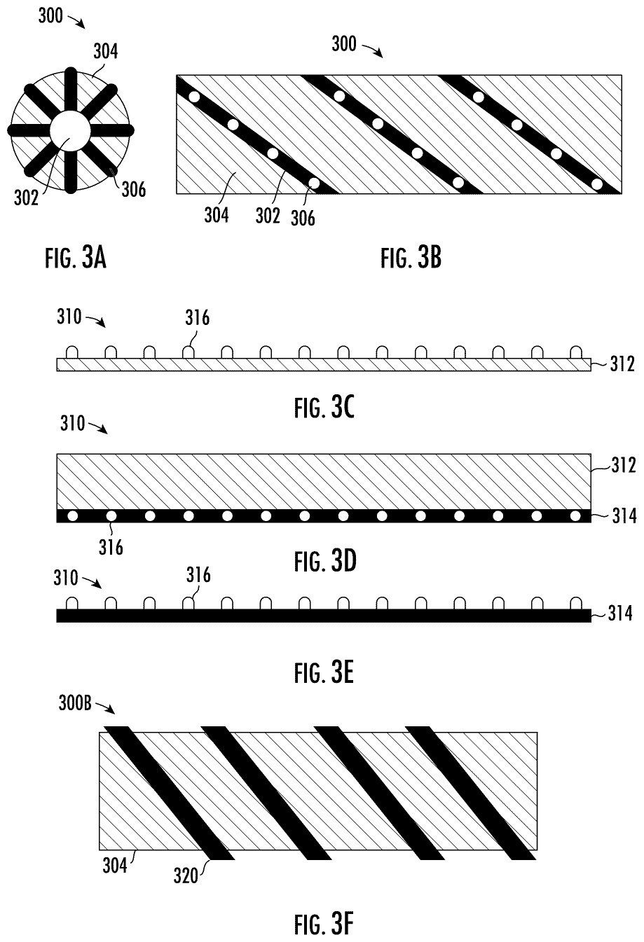

FIG. 3A is a side view of one example of a passive roller 300 (which is an example of the rear cleaning assembly 118 of FIG. 1) for the surface cleaner 100 of FIG. 1, consistent with the present disclosure. The passive roller 300 includes a cylindrical core 302. In an embodiment, the core 302 may be constructed of a metal alloy (e.g., steel) or a plastic. In another embodiment, the core 302 may be constructed of, for example, rubber or another elastomeric compound. The cylindrical core 302 may include cover 304, which may be a plush material, e.g., a microfiber material. The cover 304 may be interspersed with a plurality of spikes 306, which radiate in an outward helical direction from the core 302 and extend beyond an outer surface of the cover 304.

In an embodiment, the spikes 306 may be configured to contact the surface to be cleaned 180 such that when the surface cleaner 100 is moved, friction with the surface to be cleaned 180 urges the passive roller 300 to rotate. In another embodiment, the spikes 306 may not contact the surface to be cleaned 180. In an embodiment, the rotation of the passive roller 300 urges debris towards the suction inlet 110 of the cleaning head 102 to facilitate the cleaning operation. In an embodiment, the spikes 306 may be used for anti-hair wrap purposes.

FIG. 3B is a front view of the example passive roller of FIG. 3A, consistent with the present disclosure. In the example front view of FIG. 3B, the spikes 306 are shown to be arranged in a helix around the core 302. In an embodiment, the spikes 306 may be attached to the core 302 and extend radially from the core 302, and the cover 304 may include strips of material wound between the spikes. In another embodiment, the cover 304 may be a continuous material wound around the core 302, with strips of the spikes 306 wound around the cover 304.

In another embodiment, the spikes 306 may be formed into the cover 304. In this embodiment, the spikes 316 and the cover 304 may extend from a common substrate (not shown). In yet another embodiment (not shown), the spikes 306 may extend from a base that is received within a T-slot on the core 302 and the cover 304 may be adhered to the core 302 between the T-slots.

FIG. 3C is a back view, FIG. 3D is a top view, and FIG. 3E is a front view of one example of a covering strip for the passive roller of FIG. 3A, consistent with the present disclosure. The example of FIGS. 3C through 3E illustrates an embodiment for an alternative construction of the passive roller 300. In the example of FIGS. 3C through 3E, the core 302 is covered by a strip 310 that is wrapped around the core 302 in a helical direction. The strip 310 may include a first part 312 having a plush material, e.g., a microfiber material. The strip 310 may include a second part 314 that which may be constructed of, for example, rubber or another elastomeric compound. In an embodiment, the plurality of spikes 316 are integral to the second part 314. In another embodiment, the spikes 316 are a separate component that is inserted into the second part 314. The strip 310 is then coupled to the core 302 by wrapping the strip 310 in a helical direction around the core 302. The strip 310 may be adhered to the core 302 with any appropriate adhesive as would be known to one skilled in the art.

FIG. 3F is a front view of another example of a passive roller 300B for the surface cleaner 100 of FIG. 1, consistent with the present disclosure. Like the passive roller 300 of FIG. 3B, the passive roller 300B of FIG. 3F includes a cylindrical core 302, which may be constructed of a metal alloy (e.g., steel) or a plastic. In another embodiment, the cylindrical core 302 may be constructed of, for example, rubber or another elastomeric compound. The cylindrical core 302 may include cover 304, which may be a plush material, e.g., a microfiber material. The cover 304 may be interspersed with a plurality of helical flaps 320, which radiate outwardly from the core 302.

In an embodiment, the helical flaps 320 may extend beyond an outer surface of the cover 304 and may be configured to contact the surface to be cleaned 180 such that when the surface cleaner 100 is moved, friction with the surface to be cleaned 180 urges the passive roller 300 to rotate. In an embodiment, the helical flaps 320 may not contact the surface to be cleaned 180. In an embodiment, the rotation of the passive roller 300 urges debris towards the suction inlet 110 of the cleaning head 102 to facilitate the cleaning operation. In an embodiment, the helical flaps 320 may be used for anti-hair wrap purposes.

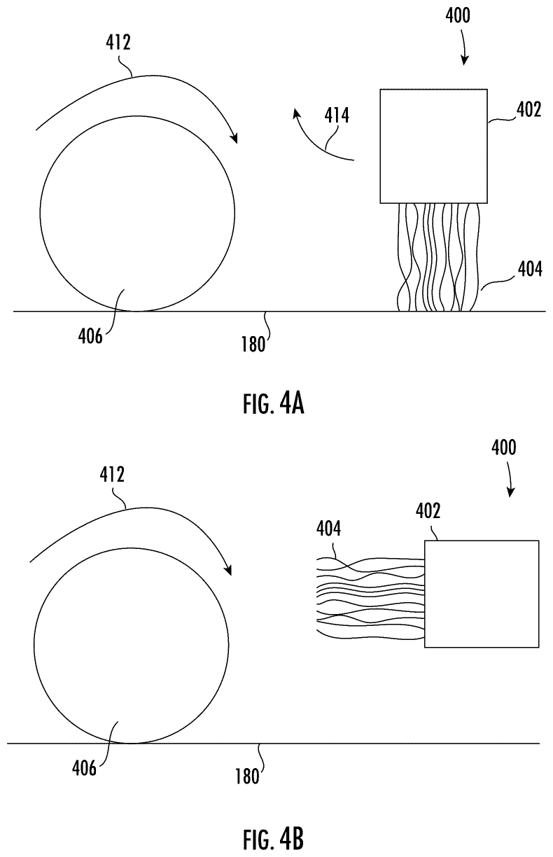

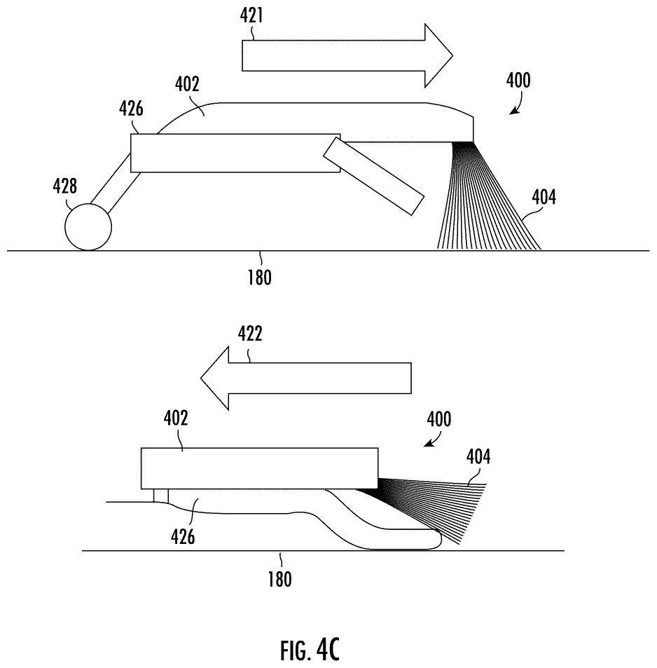

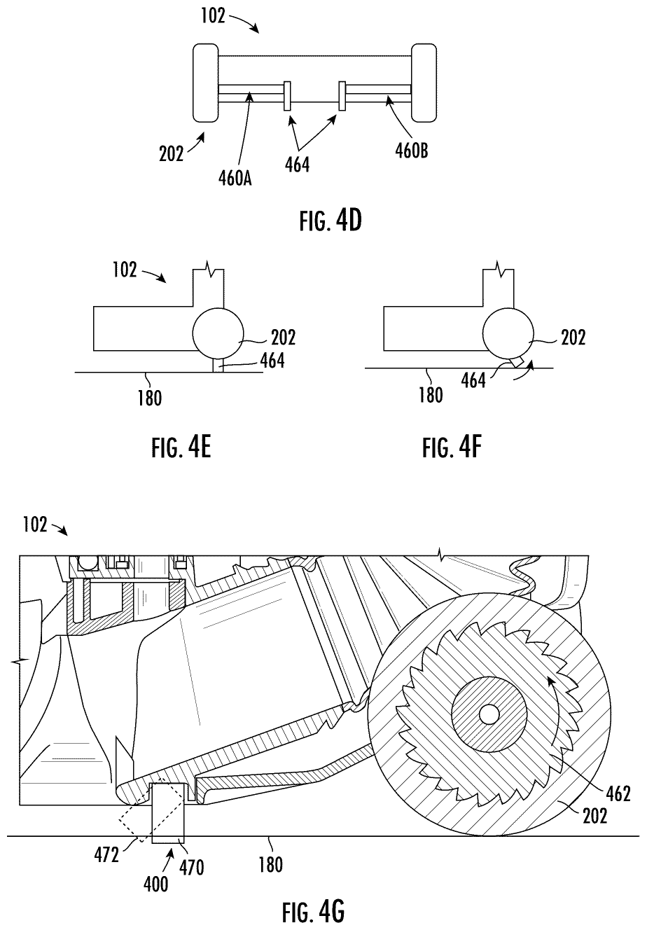

FIGS. 4A and 4B are schematic views of an illustrative embodiment of an articulating squeegee for the example surface cleaner 100 of FIG. 1, consistent with the present disclosure. FIGS. 4A and 4B includes a scraper assembly 400 (which is an example of the rear cleaning assembly 118 of FIG. 1) and one or more scraper wheels 406 coaxially disposed on the scraper assembly 400. The scraper assembly 400 includes a scraper holder 402 and a scraper element 404. In an embodiment, the scraper element 404 may be a squeegee, which may be constructed from rubber or another elastomeric compound. In another embodiment, the scraper element 404 may be a plurality of bristles. The scraper element 404 is coupled with the scraper holder 402 and configured to contact the surface to be cleaned 180 to urge debris towards the suction inlet 110 when the surface cleaner 100 is moved in the forward direction.

In FIG. 4A, the scraper assembly 400 is shown in the engaged position for forward movement of the surface cleaner 100. When the surface cleaner 100 is moved in the reverse direction, the scraper wheels 406 rotate (e.g., in a clockwise direction) as shown by direction-5 412, which urges the scraper assembly 400 to rotate as shown by direction-6 414, to allow debris on the surface to be cleaned 180 to pass underneath the scraper assembly 400 to allow the suction from the suction inlet 110 to draw the debris into the surface cleaner 100.

FIG. 4B shows the scraper assembly 400 in the disengaged position. While the illustrated example embodiment of FIGS. 4A and 4B show the scraper assembly 400 rotated approximately 90 degrees away from the surface to be cleaned 180, it should be noted that the scraper assembly 400 may be rotated in any direction and at any angle that sufficiently allows debris to pass beneath the scraper assembly 400 during the reverse cleaning. It should be noted that once the scraper assembly 400 is rotated into either the engaged position or the disengaged position, the scraper wheels 406 may be capable of continued free rotation, and not be hampered by the scraper assembly 400. In other words, once the scraper assembly 400 has rotated into position for the current direction of movement, the scraper wheels 406 disengage from the scraper assembly 400 to continue to rotate freely until the user changes the direction of movement of the surface cleaner 100.

FIG. 4C is a schematic view of another example of an articulating squeegee for the example surface cleaner 100 of FIG. 1, consistent with the present disclosure. In the illustrative embodiment of FIG. 4C, a scraper assembly 400 is disposed above a scraper cam assembly 426, which includes a scraper foot 428 disposed at one end of the scraper cam assembly 426 and configured to contact the surface to be cleaned 180.

In FIG. 4C the scraper element 404 consists of a plurality of bristles that are coupled to one end of the scraper holder 402. During forward movement of the surface cleaner 100, as shown by direction-7 421, the scraper foot 428 is urged by friction against the surface to be cleaned 180 to move in the opposite direction of direction-7 421. Such a configuration causes the scraper element 404 to contact the surface to be cleaned 180 to urge debris towards the suction inlet 110 (the scraper element 404 may extend from the scraper holder 402 to form about a 90 degree angle with the scraper holder 402). When the surface cleaner 100 is moved in the reverse direction, as shown by direction-8 422, the scraper foot 428 is urged by friction against the surface to be cleaned 180 to move in the opposite direction of direction-8 422. Such a configuration urges the scraper element 404 out of engagement with the surface to be cleaned 180. Such a configuration may be generally described as inactivating the scraper element 404. In some instances, when the scraper element 404 is inactivated, the scraper element 404 may be at least partially (e.g., entirely) concealed (e.g., by a portion of the scraper cam assembly 426). This may allow debris to pass under the scraper element 404 to be urged into the suction inlet 110 by suction from the surface cleaner 100.

FIGS. 4D through 4F are schematic views of another example of an articulating squeegee for the example surface cleaner 100 of FIG. 1, consistent with the present disclosure. The articulating squeegee of FIGS. 4D through 4F include one or more scraper assemblies, for example, scraper assembly 460A and scraper assembly 460B, and one or more half wheels 464. In the illustrative embodiment of FIGS. 4D-4F , the one or more half wheels 464 are located at the center rear of the cleaning head 102, as shown in FIG. 4D. The one or more half wheels 464 each act as a pivot for the scraper assemblies 460A and 460B that allows them to open and close depending on the direction of travel, i.e., either forward or reverse.

FIG. 4G is a schematic view of an example of the scraper assembly 400 that includes a squeegee 470, wherein the squeegee 470 is configured to articulate (e.g., pivot) from an engaging position to a disengaging position 472 (shown in phantom lines). The squeegee 470 can be configured to articulate based on a direction of movement of the cleaning head 102. The scraper assembly 400 may be incorporated with the example surface cleaner 100 of FIG. 1, consistent with the present disclosure. Like the embodiment illustrated in FIGS. 4A and 4B above, the illustrative embodiment of FIG. 4G uses the pulling motion of a user on the surface cleaner 100 to tilt or rotate at least a portion of the scraper assembly 400 (e.g., the squeegee 470) to disengage from the surface to be cleaned during the reverse movement of the surface cleaner 100. In the illustrative embodiment of FIG. 4G, the nozzle wheel 202 includes a ratchet gear 462 that is configured to tilt at least a portion of the scraper assembly 400 to disengage the squeegee 470 from contacting the surface to be cleaned when the surface cleaner 100 is moved in the reverse (pulling) direction. The ratchet gear 462 is configured to operate only during a reverse movement, to release the scraper assembly 400 to engage with the surface to be cleaned 180 during a forward movement of the surface cleaner 100, and to disengage from the scraper assembly 400 when the scraper assembly 400 has reached the engaged position or the disengaged position until the surface cleaner 100 changes direction.

An example of a surface cleaner, consistent with the present disclosure, may include an upright section, a cleaning head, one or more wheels coupled to the cleaning head, a suction motor, and a reverse cleaning assembly.

In some instances, the reverse cleaning assembly may include a nozzle wheel, the nozzle wheel coaxially coupled with a first gear, a first transmission wheel coaxially coupled with a second gear, a drive belt, the drive belt rotatably coupled with the first gear and the second gear, the drive belt configured to urge the second gear to rotate based on rotation of the first gear, a second transmission wheel rotatably coupled with the first transmission wheel, and a passive roller including a driven region rotatably coupled with the second transmission wheel, the passive roller configured to urge debris on a surface to be cleaned towards a suction inlet of the surface cleaner. In some instances, the passive roller further may include a core, a cover, and a plurality of helical flaps, the plurality of helical flaps disposed extending radially from the core outwardly beyond a cover material. In some instances, the reverse cleaning assembly may include the passive roller, the passive roller including a core, a cover, and a plurality of spikes, the plurality of spikes disposed extending radially from the core outwardly beyond a cover material. In some instances, the cover may include a plush material. In some instances, the plush material may be a microfiber material. In some instances, the reverse cleaning assembly may include a scraper assembly, one or more scraper wheels, the one or more scraper wheels coaxially coupled with the scraper assembly, the one or more scraper wheels configured to rotate the scraper assembly between an engaged position and a disengaged position based on a direction of travel of the surface cleaner and disengage from the scraper assembly when the scraper assembly has transitioned to the engaged position from the disengaged position or to the disengaged position from the engaged position. In some instances, the scraper assembly may include a scraper holder and a scraper element. In some instances, the scraper element may be selected from a group consisting of a squeegee and a plurality of bristles. In some instances, the reverse cleaning assembly may include a scraper assembly, the scraper assembly including a scraper holder and a scraper element, a scraper cam assembly, the scraper cam assembly disposed below the scraper assembly, and a scraper foot disposed at one end of the scraper cam assembly and configured to contact the surface to be cleaned and to urge the scraper cam assembly to move in a direction opposite the direction of movement of the surface cleaner, the scraper cam assembly configured to, responsive to the surface cleaner moving in a forward direction, disengage from the scraper assembly to allow the scraper element to engage with the surface to be cleaned and, responsive to the surface cleaner moving in a reverse direction, engage with the scraper assembly to urge the scraper element to be disengaged from the surface to be cleaned, thus concealing and inactivating the scraper element. In some instances, the reverse cleaning assembly may include one or more scraper assemblies and one or more half wheels, wherein at least one half wheel is disposed on each of the one or more scraper assemblies and the one or more half wheels each act as a pivot for the one or more scraper assemblies to allows them to open when the surface cleaner is moving in a reverse direction and close when the surface cleaner is moving in a forward direction. In some instances, the reverse cleaning assembly may include a nozzle wheel, a ratchet gear, the ratchet gear coaxially coupled with the nozzle wheel, a scraper assembly, and, wherein, the ratchet gear is configured to urge the scraper assembly into an engaged position when the surface cleaner is moving in a forward direction, to urge the scraper assembly into a disengaged position when the surface cleaner is moving in a reverse direction, and to disengage from the scraper assembly when the scraper assembly has reached the engaged position or the disengaged position until the surface cleaner changes direction. In some instances, the reverse cleaning assembly may include a nozzle wheel, the nozzle wheel coaxially coupled with a first gear, a first transmission gear configured to engage with the first gear to cause the first transmission gear to rotate in cooperation with the first gear, a second transmission gear configured to engage with the first transmission gear to cause the second transmission gear to rotate in cooperation with the first transmission gear, and a passive roller including a driven region configured to engage with the with the second transmission gear to cause the passive roller including the driven region to rotate in cooperation with the second transmission gear, the passive roller configured to urge debris on a surface to be cleaned towards a suction inlet of the surface cleaner.

Another example of a surface cleaner, consistent with the present disclosure, may include an upright section, a cleaning head having a suction inlet and an agitator, the upright section pivotally coupled to the cleaning head, a plurality of wheels coupled to opposing sides of the cleaning head, a suction motor fluidly coupled to the suction inlet, and a reverse cleaning assembly coupled to the cleaning head and extending between the agitator and the plurality of wheels, wherein rotational movement of at least one of the plurality of wheels is transferred to the reverse cleaning assembly.

In some instances, the reverse cleaning assembly may include a passive roller. In some instances, at least one of the plurality of wheels may include a first gear coupled to a drive belt and, wherein, movement of the drive belt causes a corresponding rotation in the passive roller. In some instances, the surface cleaner may further include a first transmission wheel and a second gear coupled to the first transmission wheel, wherein the drive belt couples to the second gear such that rotational motion of the first gear is transferred to the second gear. In some instances, the surface cleaner may further include a second transmission wheel, wherein the first transmission wheel is configured to engage the second transmission wheel to cause the second transmission wheel to rotate. In some instances, the second transmission wheel may be configured to engage the passive roller to cause the passive roller to rotate. In some instances, the passive roller may include a driven region configured to engage the second transmission wheel, the driven region being disposed between sections of an agitation material. In some instances, the reverse cleaning assembly may include a scraper assembly. In some instances, the scraper assembly may include a squeegee configured to move between an engaged position and a disengaged position. In some instances, the squeegee may be configured to move between the engaged and the disengaged positions based on a direction of movement of the cleaning head.

Another example of a surface cleaner, consistent with the present disclosure, may include a cleaning head having a suction inlet and an agitator, a plurality of wheels coupled to opposing sides of the cleaning head, a suction motor fluidly coupled to the suction inlet, and a reverse cleaning assembly coupled to the cleaning head and extending between the agitator and the plurality of wheels, wherein rotational movement of at least one of the plurality of wheels is transferred to the reverse cleaning assembly.

In some instances, the reverse cleaning assembly may include a passive roller. In some instances, at least one of the plurality of wheels may include a first gear coupled to a drive belt and, wherein, movement of the drive belt causes a corresponding rotation in the passive roller. In some instances, the surface cleaner may further include a first transmission wheel and a second gear coupled to the first transmission wheel, wherein the drive belt couples to the second gear such that rotational motion of the first gear is transferred to the second gear. In some instances, the surface cleaner may further include a second transmission wheel, wherein the first transmission wheel is configured to engage the second transmission wheel to cause the second transmission wheel to rotate. In some instances, the second transmission wheel may be configured to engage the passive roller to cause the passive roller to rotate. In some instances, the passive roller may include a driven region configured to engage the second transmission wheel, the driven region being disposed between sections of an agitation material. In some instances, the reverse cleaning assembly may include a scraper assembly. In some instances, the scraper assembly may include a squeegee configured to move between an engaged position and a disengaged position. In some instances, the squeegee may be configured to move between the engaged and the disengaged positions based on a direction of movement of the cleaning head.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising,” “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A surface cleaner comprising:
an upright section;
a cleaning head having a suction inlet and an agitator, the upright section pivotally coupled to the cleaning head;
a plurality of wheels coupled to opposing sides of the cleaning head;
a suction motor fluidly coupled to the suction inlet; and
a reverse cleaning assembly coupled to the cleaning head and extending between the agitator and the plurality of wheels, wherein rotational movement of at least one of the plurality of wheels is transferred to the reverse cleaning assembly.

2. The surface cleaner of claim 1, wherein the reverse cleaning assembly includes a passive roller.

3. The surface cleaner of claim 2, wherein at least one of the plurality of wheels includes a first gear coupled to a drive belt and, wherein, movement of the drive belt causes a corresponding rotation in the passive roller.

4. The surface cleaner of claim 3, further comprising a first transmission wheel and a second gear coupled to the first transmission wheel, wherein the drive belt couples to the second gear such that rotational motion of the first gear is transferred to the second gear.

5. The surface cleaner of claim 4, further comprising a second transmission wheel, wherein the first transmission wheel is configured to engage the second transmission wheel to cause the second transmission wheel to rotate.

6. The surface cleaner of claim 5, wherein the second transmission wheel is configured to engage the passive roller to cause the passive roller to rotate.

7. The surface cleaner of claim 6, wherein the passive roller includes a driven region configured to engage the second transmission wheel, the driven region being disposed between sections of an agitation material.

8. The surface cleaner of claim 1, wherein the reverse cleaning assembly includes a scraper assembly.

9. The surface cleaner of claim 8, wherein the scraper assembly includes a squeegee configured to move between an engaged position and a disengaged position.

10. The surface cleaner of claim 9, wherein the squeegee is configured to move between the engaged and the disengaged positions based on a direction of movement of the cleaning head.

11. A surface cleaner comprising:
a cleaning head having a suction inlet and an agitator;
a plurality of wheels coupled to opposing sides of the cleaning head;
a suction motor fluidly coupled to the suction inlet; and
a reverse cleaning assembly coupled to the cleaning head and extending between the agitator and the plurality of wheels, wherein rotational movement of at least one of the plurality of wheels is transferred to the reverse cleaning assembly.

12. The surface cleaner of claim 11, wherein the reverse cleaning assembly includes a passive roller.

13. The surface cleaner of claim 12, wherein at least one of the plurality of wheels includes a first gear coupled to a drive belt and, wherein, movement of the drive belt causes a corresponding rotation in the passive roller.

14. The surface cleaner of claim 13, further comprising a first transmission wheel and a second gear coupled to the first transmission wheel, wherein the drive belt couples to the second gear such that rotational motion of the first gear is transferred to the second gear.

15. The surface cleaner of claim 14, further comprising a second transmission wheel, wherein the first transmission wheel is configured to engage the second transmission wheel to cause the second transmission wheel to rotate.

16. The surface cleaner of claim 15, wherein the second transmission wheel is configured to engage the passive roller to cause the passive roller to rotate.

17. The surface cleaner of claim 16, wherein the passive roller includes a driven region configured to engage the second transmission wheel, the driven region being disposed between sections of an agitation material.

18. The surface cleaner of claim 11, wherein the reverse cleaning assembly includes a scraper assembly.

19. The surface cleaner of claim 18, wherein the scraper assembly includes a squeegee configured to move between an engaged position and a disengaged position.

20. The surface cleaner of claim 19, wherein the squeegee is configured to move between the engaged and the disengaged positions based on a direction of movement of the cleaning head.
